(19) United States
(12) Patent Application Publication
(10) Pub. No.: US 2009/0222620 A1
(43) Pub. Date: Sep. 3, 2009

(54) MEMORY DEVICE, INFORMATION PROCESSING APPARATUS, AND ELECTRIC POWER CONTROLLING METHOD

(76) Inventor: Tatsunori KANAI, Kanagawa (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/237,891

(22) Filed: Sep. 25, 2008

(30) Foreign Application Priority Data
Feb. 29, 2008 (JP) 2008-050821

(51) Int. Cl. G06F 12/00

(52) U.S. Cl. 711/104; 711/107; 713/300; 711/154; 711/E12.001

(57) ABSTRACT

A memory device includes a memory unit that is nonvolatile and is made up of a plurality of memory areas; first retaining units each of which is provided in correspondence with a different one of the memory areas and each of which retains first setting information that defines whether a corresponding one of the memory areas is in an active state or a stop state; and an electric power-source controlling unit that supplies electric power to one or more of the memory areas that correspond to the first setting information defining the memory areas to be in the active state, and stops electric power supply to one or more of the memory areas that correspond to the first setting information defining the memory areas to be in the stop state.

### CROSS-REFERENCE TO RELATED APPLICATIONS

This application is based upon and claims the benefit of priority from the prior Japanese Patent Application No. 2008-50821, filed on Feb. 29, 2008; the entire contents of which are incorporated herein by reference.

### BACKGROUND OF THE INVENTION

1. Field of the Invention

The present invention relates to a memory device, an information processing apparatus, and an electric power controlling method for controlling electric power related to nonvolatile memories.

2. Description of the Related Art

Conventionally, for embedded systems in which various types of memories and input/output circuits are joined together with a processor provided at the core thereof, attempts have been made to reduce the electric power consumption for the entire embedded system by stopping the electric power supply to the devices that are not in use. For example, JP-A 2006-172059 (KOKAI) discloses a technique for normally maintaining a state where no electric power is supplied to the functional units, so that electric power is supplied only when each of the functional units needs to operate and perform a process. Generally speaking, however, each of the main storage devices is configured with a volatile memory such as a Static Random Access Memory (SRAM) or a Dynamic Random Access Memory (DRAM). Thus, it is not possible to stop the electric power supply thereto without discretion.

In recent years, nonvolatile memories called universal memories such as Magnetoresistive Random Access Memories (MRAMS) and Ferroelectric Random Access Memories (FeRAMs) have been developed. These universal memories have characteristics where they allow high-speed access and they are nonvolatile like flash memories. Thus, by configuring a main storage device with a universal memory, instead of with a volatile memory as described above, it is possible to keep the data in the main storage device, even if the electric power supply, including the one to the main storage device, is stopped while the processor is in a standby mode.

However, according to the technique disclosed in JP-A 2006-172059 (KOKAI) described above, the control to turn on and off the electric power supply is exercised in units of devices. Thus, even if access is made to only such data that is stored in a part of the storage area of the main storage device, electric power needs to be supplied to the entire main storage device. Accordingly, even if the main storage device is configured with a nonvolatile memory such as an MRAM or an FeRAM, the control to turn on and off the electric power supply can be exercised only for the entire main storage device, just like other devices. Thus, there is a possibility that electric power may wastefully be consumed.

### SUMMARY OF THE INVENTION

According to one aspect of the present invention, a memory device includes a memory unit that is nonvolatile and is made up of a plurality of memory areas; first retaining units each of which is provided in correspondence with a different one of the memory areas and each of which retains first setting information that defines whether a corresponding one of the memory areas is in an active state or a stop state; and an electric power-source controlling unit that supplies electric power to one or more of the memory areas that correspond to the first setting information defining the memory areas to be in the active state, and stops electric power supply to one or more of the memory areas that correspond to the first setting information defining the memory areas to be in the stop state.

According to another aspect of the present invention, an information processing apparatus includes a memory unit that is nonvolatile and is made up of a plurality of memory areas; first retaining units each of which is provided in correspondence with a different one of the memory areas and each of which retains first setting information that defines whether a corresponding one of the memory areas is in an active state or a stop state; an accessing unit that is operable to make access to the memory unit; an identifying unit that identifies one of the memory areas containing an address that is a target of the access as an access target area; a setting changing unit that changes a setting so that the first setting information corresponding to the access target area defines the access target area to be in the active state; and an electric power-source controlling unit that supplies electric power to one or more of the memory areas that correspond to the first setting information defining the memory areas to be in the active state, and stops electric power supply to one or more of the memory areas that correspond to the first setting information defining the memory areas to be in the stop state.

According to still another aspect of the present invention, an electric power controlling method implemented by an information processing apparatus, the apparatus including a memory unit that is nonvolatile and is made up of a plurality of memory areas, and first retaining units each of which is provided in correspondence with a different one of the memory areas and each of which retains first setting information that defines whether a corresponding one of the memory areas is in an active state or a stop state, the method comprising: making an access to the memory unit by an accessing unit; identifying one of the memory areas containing an address that is a target of the access as an access target area by an identifying unit; changing a setting so that the first setting information corresponding to the access target area defines the access target area to be in the active state, by a setting changing unit; and supplying electric power to one or more of the memory areas that correspond to the first setting information defining the memory areas to be in the active state, and stopping electric power supply to one or more of the memory areas that correspond to the first setting information defining the memory areas to be in the stop state.

### BRIEF DESCRIPTION OF THE DRAWINGS

FIG. 1 is a diagram of an information processing apparatus according to a first embodiment of the present invention;

FIG. 2 is a diagram for explaining a relationship between each of memory devices and a processor shown in FIG. 1;

FIG. 3 is a drawing for explaining a relationship between memory areas in a nonvolatile memory and a mode setting register group shown in FIG. 2;

FIG. 4 is a drawing of an example of an access management table shown in FIG. 2;

FIG. 5 is a flowchart of a procedure in an access process according to the first embodiment;

FIG. 6 is a flowchart of a procedure in a post-access process according to the first embodiment;

FIG. 7 is a flowchart of a procedure in an electric power controlling process according to the first embodiment;

FIG. 8 is a diagram of an information processing apparatus according to a modification example of the first embodiment;

FIG. 9 is a drawing for explaining a relationship between a page table and memory areas in a nonvolatile memory shown in FIG. 8;

FIG. 10 is a flowchart of a procedure in an access process according to the modification example of the first embodiment;

FIG. 11 is a flowchart of a procedure in a post-access process according to the modification example of the first embodiment;

FIG. 12 is a diagram of an information processing apparatus according to a second embodiment of the present invention;

FIG. 13 is a diagram of an information processing apparatus according to a third embodiment of the present invention;

FIG. 14 is a flowchart of a procedure in an electric power controlling process according to the third embodiment;

FIG. 15 is a diagram of an information processing apparatus according to a fourth embodiment of the present invention; and

FIG. 16 is a flowchart of a procedure in an electric power controlling process according to the fourth embodiment.

### DETAILED DESCRIPTION OF THE INVENTION

Exemplary embodiments of a memory device, an information processing apparatus, and an electric power controlling method according to the present invention will be explained in detail, with reference to the accompanying drawings. In the description of the exemplary embodiments below, examples will be used in which the present invention is applied to an information processing apparatus that includes, as the main storage devices thereof, nonvolatile memories each of which is configured with an MRAM, an FeRAM, or the like. However, the configurations to which the present invention can be applied are not limited to these examples.

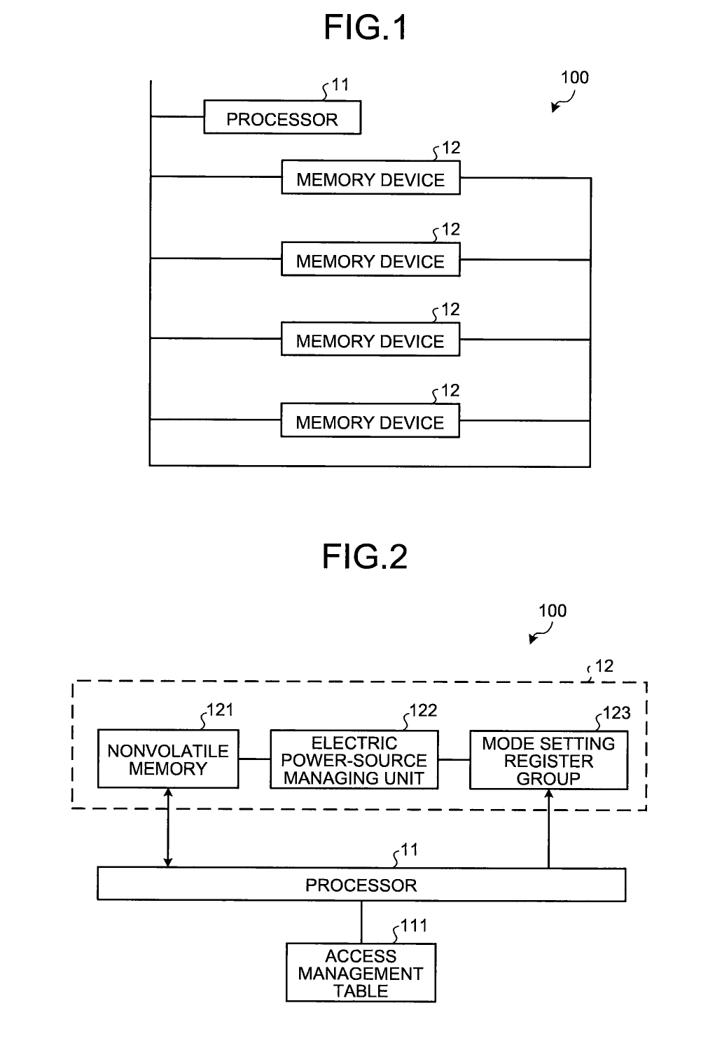

FIG. 1 is a block diagram of an information processing apparatus 100 according to a first embodiment of the present invention. As shown in FIG. 1, the information processing apparatus 100 includes a processor 11 and four memory devices 12. These constituent elements are connected to one another via a bus 13.

The processor 11 is, for example, a Central Processing Unit (CPU), a Digital Signal Processor (DSP), or a Field Programmable Gate Array (FPGA). The processor 11 performs various types of processes while using nonvolatile memories 121 (explained later) as the main storage devices. The operation of the processor 11 will be explained later.

Each of the memory devices 12 includes a nonvolatile memory device that functions as one of the main storage devices of the processor 11. The memory devices 12 are connected in parallel to the processor 11. In FIG. 1, an example is shown in which the information processing apparatus 100 includes the four memory devices 12; however, the number of memory devices 12 included is not limited to this example.

FIG. 2 is a diagram for explaining a relationship between each of the memory devices 12 and the processor 11. As shown in FIG. 2, each of the memory devices 12 includes the nonvolatile memory 121, an electric power-source managing unit 122, and a mode setting register group 123.

The nonvolatile memory 121 is configured with a readable/writable nonvolatile memory device such as an MRAM, an FeRAM, a Phase-change Random Access Memory (PRAM), or a Resistance Random Access Memory (RRAM).

Another arrangement is acceptable in which the nonvolatile memory 121 is configured with a chip (i.e., a die) packaged in, for example, a Dual In-line Package (DIP) or a Ball Grid Array (BGA). Yet another arrangement is acceptable in which the die for the nonvolatile memory 121 is installed in a multi-chip module or the like.

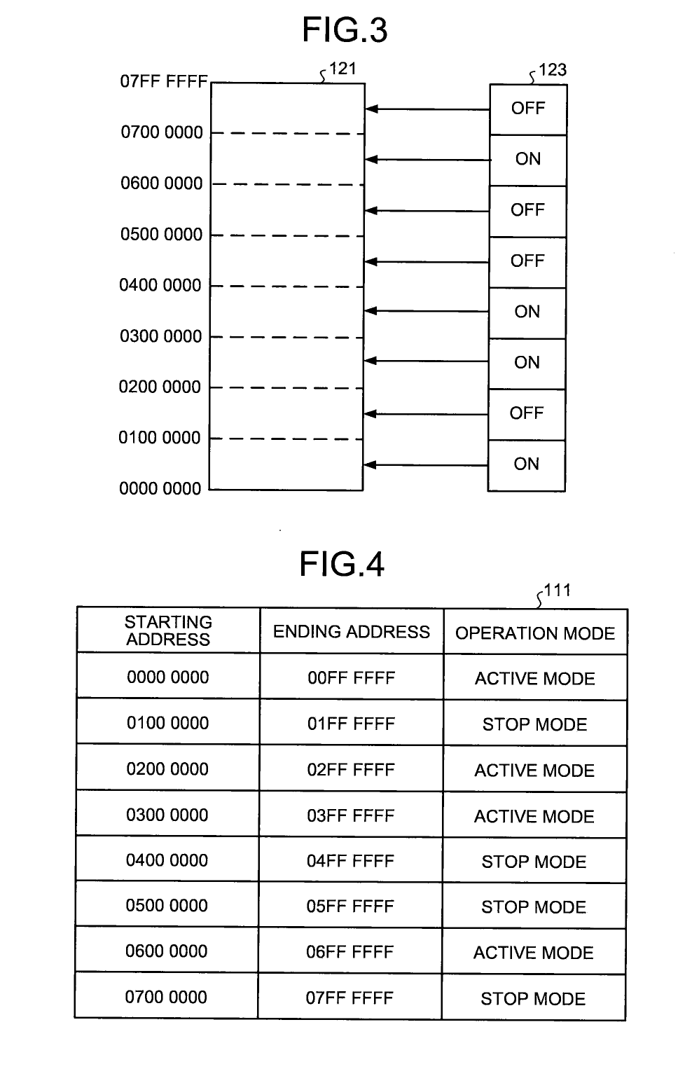

The electric power-source managing unit 122 supplies the nonvolatile memory 121 with electric power supplied from an electric power source (not shown). The electric power-source managing unit 122 also controls the amount of the supplied electric power in units of memory areas, according to the register values in the registers included in the mode setting register group 123, the registers being provided in correspondence with a different one of the memory areas. Next, a relationship between the electric power-source managing unit 122 and the mode setting register group 123 will be explained, with reference to FIG. 3.

FIG. 3 is a drawing for explaining the relationship between the memory areas in the nonvolatile memory 121 and the mode setting register group 123. Shown in FIG. 3 is an example in which the areas in the nonvolatile memory 121 corresponding to a total of 128 megabytes (MB), with the addresses from “00000000” through “07FFFFFF”, are assigned as a memory space used by the processor 11. In the example shown in FIG. 3, each of the memory areas is an area corresponding to 16 MB obtained by dividing the 128-MB memory space into eight sections. The number of memory areas and the capacity of each of the memory areas shown in FIG. 3 are only examples. It is possible to change, as necessary, the number of memory areas and the capacity thereof according to the memory devices being used and the environment.

The mode setting register group 123 includes the plurality of registers each of which corresponds to a different one of the memory areas included in the nonvolatile memory 121. Each of the registers stores therein setting information that defines whether the corresponding one of the memory areas should be in an active state or a stop state. More specifically, each of the registers in the mode setting register group 123 stores therein a binary register value (i.e., 0 or 1) that defines whether the electric power supply to the corresponding memory area should be ON or OFF.

The electric power-source managing unit 122 individually controls the electric power to be supplied to each of the memory areas, according to the register value specified in the corresponding one of the registers included in the mode setting register group 123. More specifically, by supplying electric power, the electric power-source managing unit 122 causes one or more of the memory areas whose register values are “ON” to be in an active state and to become accessible from the processor 11. Hereinafter, the state of each memory area being in an active state (i.e., being accessible from the processor 11) will be referred to as being in the “active mode”.

Further, by stopping or inhibiting the electric power supply, the electric power-source managing unit 122 causes one or more of the memory areas whose register values are “OFF” to be in a stop state. In this situation, “inhibiting the electric power supply” means to cause the one or more of the memory areas to operate with low electric power consumption, i.e., to cause the one or more of the memory areas to be in a sleep state. In other words, each of the memory areas that are in a stop state is inaccessible from the processor 11. Hereinafter, the state of each memory area being in a stop state (i.e., being inaccessible from the processor 11) will be referred to as being in the “stop mode”.

In the configuration described above, the processor 11 accesses the nonvolatile memories 121, while changing the register values in the mode setting register group 123, based on an access management table 111 stored in a storage medium (not shown). The access management table 111 may be stored in any device. For example, in the case where the processor 11 includes a built-in storage medium, the access management table 111 may be stored in the processor 11. Alternatively, the nonvolatile memories 121 may be used for storing the access management table 111 therein. In the latter situation, it is preferable to store the access management table 111 in such a memory area in the nonvolatile memories 121 that is not a target of the electric power controlling process described later.

FIG. 4 is a drawing of an example of the access management table 111. As shown in FIG. 4, for each of the memory areas in the nonvolatile memory 121, the access management table 111 has registered therein the starting address, the ending address, and the operation mode, while keeping them in correspondence with one another. Each of the lines in the access management table 111 corresponds to a different one of the memory areas. In the operation mode column, the state (i.e., active mode or stop mode) of each of the memory areas is recorded. Every time a register value in the mode setting register group 123 is changed, the operation mode is updated according to the register value. In the example shown in FIG. 4, the starting address, the ending address, and the operation mode of each of the memory areas shown in FIG. 3 are indicated.

When it has become necessary for the processor 11 to access any of the nonvolatile memories 121 due to the execution of a computer program (hereinafter a “program”) or the like, the processor 11 refers to the access management table 111 and judges whether the operation mode of the memory area containing the memory address that is the target of the access (hereinafter, the “access target”) is in the “active mode”. In the case where the processor 11 has judged that the memory area containing the memory address that is the access target is in the “active mode”, the processor 11 accesses the memory address that is the access target.

On the contrary, in the case where the processor 11 has judged that the memory area containing the memory address that is the access target is in the “stop mode”, the processor 11 sets the register value in the mode setting register group 123 that corresponds to the memory area to “ON” and changes the operation mode in the access management table 111 that corresponds to the memory area to the “active mode”. In this situation, the processor 11 waits a predetermined period of time until the memory area whose register value has been changed to “ON” starts operating in a stable manner, before accessing the memory address that is the access target. The period of time the processor 11 waits is a predetermined length of time, and the length may be arbitrary.

When having finished executing the program, the processor 11 changes the operation mode in the access management table 111 that corresponds to the memory area currently in the “active mode” to the “stop mode” and sets the register value in the mode setting register group 123 that corresponds to the memory area to “OFF”.

In this situation, it is preferable to change the operation mode from the “active mode” to the “stop mode” after a predetermined period of time has elapsed, rather than immediately after the execution of the program is finished. More specifically, when the execution of the program has been finished, the processor 11 starts measuring the period of time during which the memory area being in the “active mode” is not used, and when the predetermined period of time has elapsed, the processor 11 changes the operation mode from the “active mode” to the “stop mode”. With this arrangement, if it has become necessary to access the memory area again within the predetermined period of time after the execution of the program using the same memory area is finished, the processor 11 is able to continue to perform the process without having to change the operation mode. Thus, it is possible to allow the processor 11 to perform the processes more efficiently. The length of the predetermined period of time the processor 11 waits before changing the operation mode from the “active mode” to the “stop” mode may be arbitrary. It is, however, preferable to dynamically determine the length according to the processes performed by the processor 11. Further, according to the first embodiment, the post-access process to change the operation mode from the “active mode” to the “stop mode” is performed immediately after the access process is performed. However, another arrangement is acceptable in which the process is ended once the access made to the memory area has been completed, before the post-access process is performed as another process.

In the case where the processor 11 includes a write-back cache memory, there is a possibility that the data that has been read from the address that is the access target is cached in the cache memory. For this reason, before changing the register value to “OFF”, the processor 11 performs a process to write the data that has been cached with regard to the memory area containing the memory address that is the access target, from the cache memory back into the memory area.

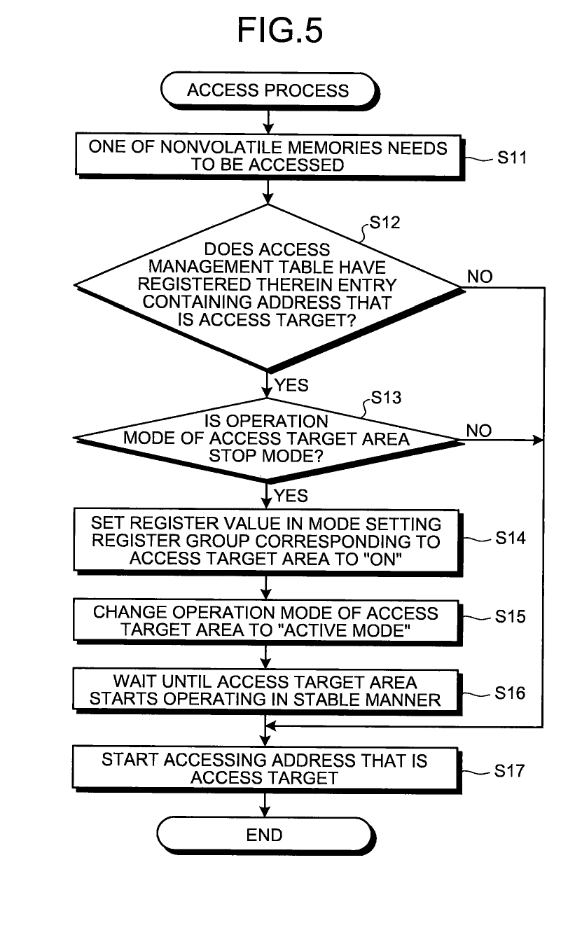

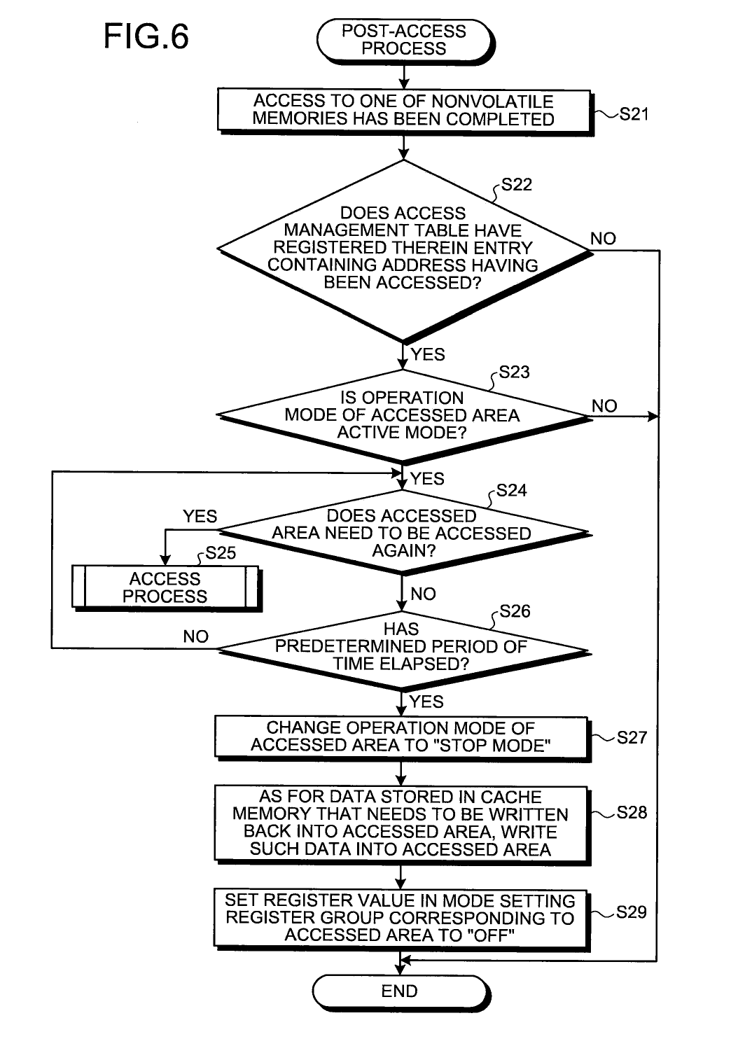

Next, the operation performed by the processor 11 in relation to making access to any of the nonvolatile memories 121 will be explained, with reference to FIGS. 5 and 6.

FIG. 5 is a flowchart of a procedure in a process (i.e., an access process) that is performed when it has become necessary for the processor 11 to access any of the nonvolatile memories 121. First, when it has become necessary for the processor 11 to access one of the nonvolatile memories 121 to execute a predetermined program or the like (Step S11), the processor 11 judges whether the access management table 111 has registered therein an entry (i.e., a memory area) containing the memory address that is the access target (Step S12). In the case where the processor 11 has judged that the access management table 111 has registered therein no such entry that contains the memory address that is the access target (No at Step S12), the process proceeds to Step S17 immediately.

On the contrary, in the case where the processor 11 has judged at Step S12 that the access management table 111 has registered therein the specific memory area (hereinafter, the “access target area”) that contains the memory address that is the access target (Yes at Step S12), the processor 11 refers to the access management table 111 and judges whether the operation mode of the access target area is the “stop mode” (Step S13). In the case where the processor 11 has judged that the operation mode of the access target area is the “active mode” (No at Step S13), the process proceeds to Step S17 immediately.

On the contrary, in the case where the processor 11 has judged at Step S13 that the operation mode of the access target area is the “stop mode” (Yes at Step S13), the processor 11 sets the register value in the mode setting register group 123 that corresponds to the access target area to “ON” (Step S14).

Subsequently, the processor 11 changes the operation mode in the access management table 111 that corresponds to the access target area to the “active mode” (Step S15) and waits the predetermined period of time until the access target area starts operating in a stable manner (Step S16). The process then proceeds to Step S17.

At Step S17, the processor 11 accesses the memory address that is the access target (Step S17), and the process ends.

Next, a process (i.e., a post-access process) that is performed after the access made to one of the nonvolatile memories 121 has been completed will be explained, with reference to FIG. 6. FIG. 6 is a flowchart of a procedure in the post-access process performed by the processor 11.

When having completed the execution of a program or the like and completed the access to the nonvolatile memory 121 (Step S21), the processor 11 judges whether the access management table 111 has registered therein an entry (i.e., a memory area) that contains the memory address to which the access has been made (hereinafter, “the accessed memory address”) (Step S22). In the case where the processor 11 has judged that the access management table 111 has registered therein no such entry that contains the accessed memory address (No at Step S22), the process ends immediately.

On the other hand, in the case where the processor 11 has judged at Step S22 that the access management table 111 has registered therein the specific memory area (hereinafter, the “accessed area”) that contains the accessed memory address (Yes at Step S22), the processor 11 refers to the access management table 111 and judges whether the operation mode of the accessed area is the “active mode” (Step S23). In the case where the processor 11 has judged that the operation mode of the accessed area is the “stop mode” (No at Step S23), the process ends immediately.

On the contrary, in the case where the processor 11 has judged at Step S23 that the operation mode of the accessed area is the “active mode” (Yes at Step S23), the processor 11 judges whether it has become necessary again for the processor 11 to access any part of the accessed area (Step S24). In the case where the processor 11 has detected the need to access the accessed area again (Yes at Step S24), the processor 11 performs the access process explained with reference to FIG. 5 on the accessed area to which the processor 11 needs to access again (Step S25).

On the contrary, in the case where the processor 11 does not detect at Step S24 the need to access the accessed area again (No at Step S24), the processor 11 further judges whether the predetermined period of time has elapsed since the access made to the nonvolatile memory 121 is completed (Step S26). In the case where the processor 11 has judged that the predetermined period of time has not yet elapsed (No at Step S26), the process returns to Step S24.

On the contrary, in the case where the processor 11 has judged at Step S26 that the predetermined period of time has elapsed (Yes at Step S26), the processor 11 changes the operation mode in the access management table 111 that corresponds to the accessed area to the “stop mode” (Step S27). In the case where the processor 11 includes a write-back cache memory, the processor 11 performs the process to read such data that needs to be written back into the accessed area from the cache memory and to write the read data back into the accessed area (Step S28).

Subsequently, the processor 11 sets the register value in the mode setting register group 123 that corresponds to the accessed area to “OFF” (Step S29), and the process ends. According to the first embodiment, the post-access process to change the operation mode from the “active mode” to the “stop mode” is performed immediately after the access process is performed. However, another arrangement is acceptable in which the process is ended once the access made to the nonvolatile memory has been completed, before the post-access process is performed as another process.

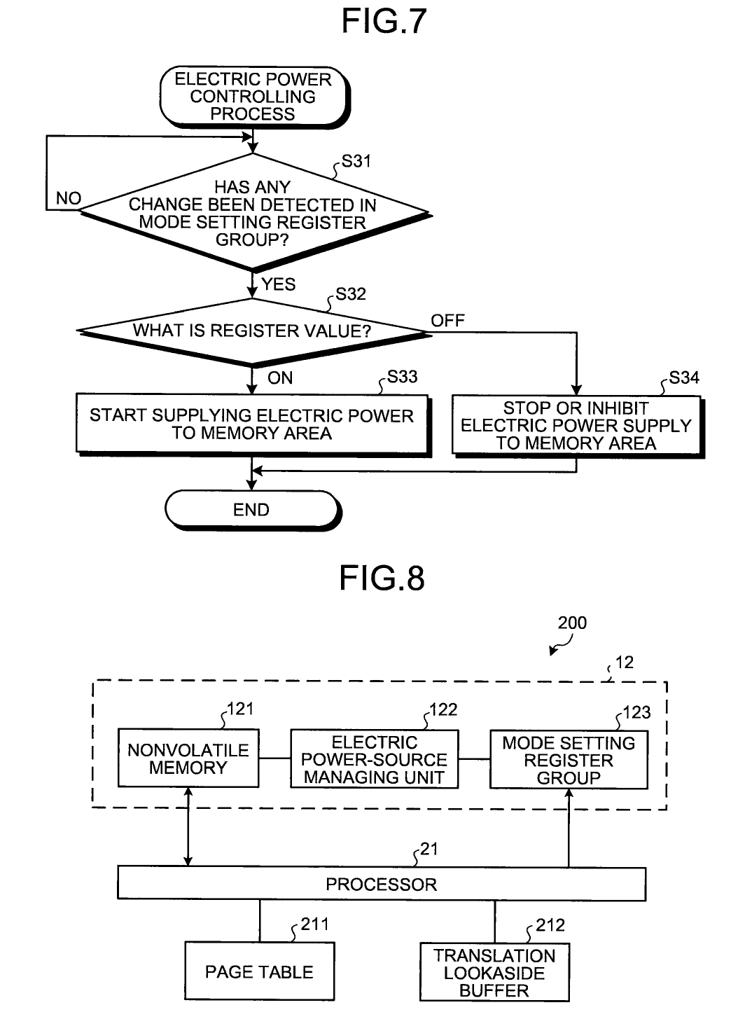

Next, an operation of each of the memory devices 12 will be explained, with reference to FIG. 7. FIG. 7 is a flowchart of a procedure in an electric power controlling process related to the nonvolatile memories 121. The electric power controlling process is performed by the electric power-source managing unit 122 according to the process performed at Step S14 or Step S29 described above.

First, the electric power-source managing unit 122 monitors the register values in the mode setting register group 123 and continues the electric power control that is currently exercised as long as none of the register values in the mode setting register group 123 is changed (No at Step S31). When the electric power-source managing unit 122 has detected that at least one of the register values in the mode setting register group 123 has been changed by the processor 11 (Yes at Step S31), the electric power-source managing unit 122 identifies the register values in the mode setting register group 123 (Step S32).

In this situation, as for the memory areas whose register values in the mode setting register group 123 are “ON” (ON at Step S32), the electric power-source managing unit 122 causes the memory areas to be in the active mode by start supplying electric power to each of the memory areas (Step S33).

On the other hand, as for the memory areas whose register values in the mode setting register group 123 are “OFF” (OFF at Step S32), the electric power-source managing unit 122 causes the memory areas to be in the stop mode by stopping or inhibiting the electric power supply to each of the memory areas (Step S34).

With the arrangements described above, for example, when it has become necessary for the processor 11 to access a part of the memory areas in any of the nonvolatile memories 121, it is possible to cause only the memory areas that are the access targets to be in the active mode, while keeping the other memory areas in the stop mode.

As a result, it is possible to reduce the amount of electric power supplied to the nonvolatile memories 121 while the functions of the nonvolatile memories 121 with respect to the processor 11 are maintained. It is therefore possible to reduce the electric power consumption.

As explained above, according to the first embodiment, it is possible to reduce the electric power consumption of the nonvolatile memories 121 by exercising the electric power control in units of memory areas included in each of the nonvolatile memories 121. Thus, it is possible to exercise the electric power control related to the nonvolatile memories more efficiently.

The access management table 111 shown in FIG. 4 stores therein the three types of information such as the starting address, the ending address, and the operation mode for each of the memory areas. However, it is acceptable to configure the access management table 111 so as to store other types of information therein, as long as it is possible to compare the stored information with the memory address that is the access target. For example, another arrangement is acceptable in which the access management table 111 stores therein, instead of the ending address, the size of the area from the starting address through the ending address for each of the memory areas.

Further, yet another arrangement is acceptable in which, without having the operation mode column, the access management table 111 stores therein only the address ranges of the memory areas that are in the stop mode so that other address ranges that are not shown in the access management table 111 are treated as being in the active mode. Conversely, yet another arrangement is acceptable in which the access management table 111 stores therein only the address ranges of the memory areas that are in the active mode so that other address ranges that are not shown in the access management table 111 are treated as being in the stop mode.

According to the first embodiment, the memory areas that are in the stop mode are detected by referring to the access management table 111. However, in the case where the processor 11 has a memory protection function, it is possible to detect access to any of the memory areas that are in the stop mode by using the memory protection function. In this situation, the memory protection function is a function that, for instance, when a program “runs away” (i.e., behaves erratically), protects the memory areas from and to which data is read and written by the program so that the memory areas will not be damaged. For example, Chapter 13 of the book entitled “ARM System Developers' Guide” by Morgan Kaufmann (International Standard Book Number [ISBN]:1-55860-874-5) discloses a memory protection function called Memory Protection Units that are used for Advanced RISC Machines (ARM) processors (RISC=Reduced Instruction Set Computer).

By using the memory protection function as described above, it is possible to assign a protecting attribute to each of a plurality of address ranges (i.e., memory areas) in the memory space. In this situation, by assigning a protecting attribute that prohibits access, an interrupt occurs when access is made to any of the address ranges to which the protecting attribute has been assigned. Thus, it is possible to suspend the execution of the program. In other words, by using the memory protection function and assigning the access prohibiting attribute to each of the memory areas that are in the stop mode, it is possible to detect the access made to any of the memory areas that are in the stop mode.

Further, according to the first embodiment, the register value is changed from “ON” to “OFF” when the access is completed. However, the register value may be changed at an arbitrary point in time. For example, another arrangement is acceptable in which the processor 11 starts measuring time when access is made to any of the nonvolatile memories 121 so that, when a predetermined period of time has elapsed, the register values in the entire mode setting register group 123 are set to “OFF”. Yet another arrangement is acceptable in which, when a predetermined period of time has elapsed, the register values in a predetermined number of registers are sequentially set to “OFF”. In either situation, according to the changes made in the register values, the processor 11 changes the operation modes registered in the access management table 111 that correspond to those memory areas to the “stop mode”. As a result, while there is no need to access each nonvolatile memory 121, it is possible stop or inhibit the electric power supply to the nonvolatile memory 121. Thus, it is possible to further reduce the electric power consumption of the information processing apparatus 100.

The predetermined period of time that is used as a trigger may be obtained from a time measuring unit (not shown) such as a Real Time Clock (RTC) that measures time. The length of the predetermined period of time may be arbitrary.

There is no particular restriction about the memory areas within the nonvolatile memories 121 that are accessed by the processor 11. As additional information, as for allocation of a working area that is necessary when a program is executed, it is possible to exercise the electric power control related to the nonvolatile memories 121 more efficiently by using a memory managing method explained below.

Generally speaking, when a program needs to use a memory as a working area, the program calls a malloc function or the like to have a memory area allocated. When the program no longer needs to use the memory as a working area, the program calls a free function or the like and releases the memory area. This process is realized by exercising memory management where a large-sized memory area allocated in advance is divided into sections each having a required smaller size and assigned to the program so that, when the program no longer needs one or more of the sections, the unnecessary sections are collected and re-used.

By having the arrangement in which the processor 11 exercises the memory management described above in units of memory areas, it is possible to configure so that, in the case where a program needs to use memory, it is possible to select which one of the memory areas the memory is allocated from. As a result, it is possible to allocate the working area efficiently.

Further, in the case where the program requests that another memory area should be allocated, the processor 11 refers to the access management table 111 and the mode setting register group 123 and allocates a working area, while giving a higher priority to the memory areas that are currently in an active state. With this arrangement, the program is able to use the allocated working area immediately. In addition, it is possible to avoid the situation where other memory areas are newly changed from a stop state to an active state. Thus, it is possible to exercise the electric power control related to the nonvolatile memories 121 more efficiently.

As another example of a memory managing method, an arrangement is acceptable in which the working area used by one program is allocated from the same memory area, always or as long as the circumstances allow. In this situation, the processor 11 remembers the memory area from which the working area was allocated last time for a certain program, and when the program needs a working area again, the processor 11 allocates the working area from the same memory area, as long as the circumstances allow. With this arrangement, it is possible to reduce the number of memory areas that are used by each program. Accordingly, it is possible to keep a larger number of memory areas in a stop state and further reduce the electric power consumption.

Next, a modification example of the first embodiment in which the memory areas are accessed by using a page table in a memory managing mechanism will be explained. Some of the configurations that are the same as those in the first embodiment will be referred to by using the same reference characters, and the explanation thereof will be omitted.

FIG. 8 is a diagram of an information processing apparatus 200 according to the modification example of the first embodiment. Although only one memory device 12 is shown in FIG. 8, the relationship between a processor 21 and the memory devices 12 are the same as the relationship shown in FIG. 1.

The processor 21 is a processing device similar to the processor 11. The processor 21 performs various types of processes while using the nonvolatile memories 121 in the memory devices 12 as the main storage devices. The processor 21 includes a memory managing mechanism for the nonvolatile memories 121. A page table 211 and a translation lookaside buffer 212 that are used by the memory managing mechanism are stored in a storage medium (not shown).

The device that stores therein the page table 211 and the translation lookaside buffer 212 may be configured with any type of device. For example, in the case where the processor 21 includes a built-in storage medium, it is acceptable to store the page table 211 and the translation lookaside buffer 212 in the processor 21. Alternatively, the nonvolatile memories 121 may be used for storing the page table 211 and the translation lookaside buffer 212 therein. In the latter situation, it is preferable to store the page table 211 and the translation lookaside buffer 212 in such a memory area in the nonvolatile memories that is not a target of the electric power controlling process.

In the present example, the memory managing mechanism is a mechanism that manages and protects the memory space in the nonvolatile memories 121. For example, Chapter 14 of the book entitled “ARM System Developers' Guide” by Morgan Kaufmann (International Standard Book Number [ISBN]:1-55860-874-5) discloses a memory managing mechanism called Memory Management Units that are used for ARM processors. The memory managing mechanism realizes a virtual storage by converting addresses and controlling accesses while using the page table 211.

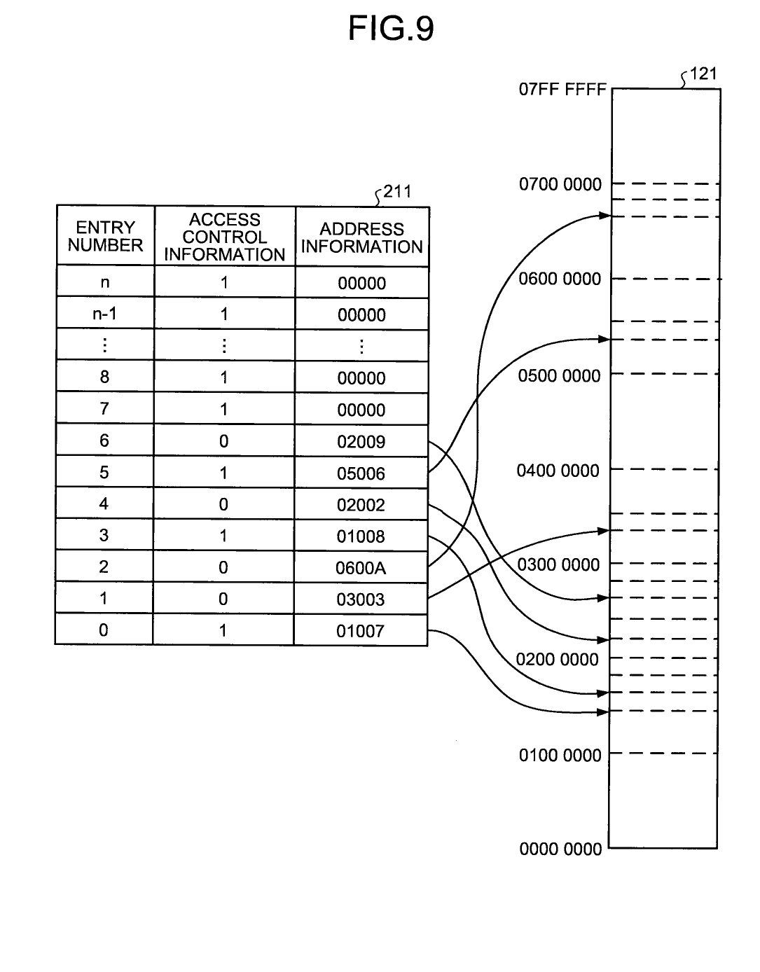

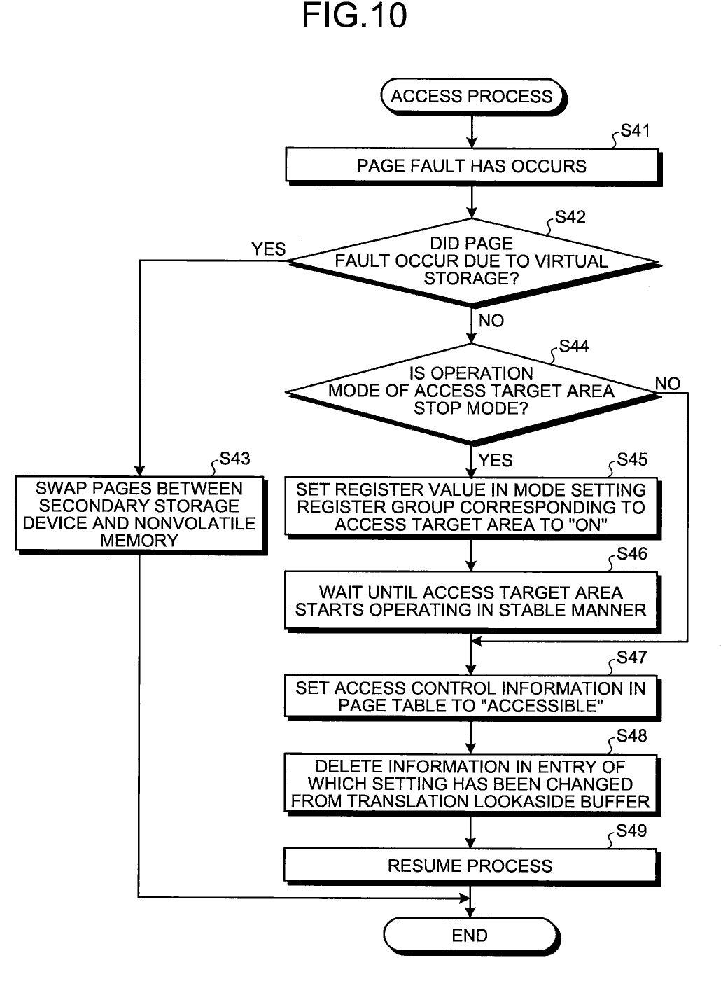

FIG. 9 is a drawing for explaining a relationship between the page table 211 and the memory areas in any of the nonvolatile memories 121. As shown in FIG. 9, the page table 211 has registered therein pieces of access control information and piece of address information while keeping them in correspondence with one another. An entry number is assigned to each of the sets made up of a piece of access control information and a piece of address information. In the example shown in FIG. 9, the page size is 4 kilobytes (KB).

In the present example, each of the pieces of access control information has recorded therein information that indicates whether access is possible or not. According to the present modification example, a piece of access control information “0” indicates that access is possible (i.e., “accessible”). On the contrary, a piece of access control information “1” indicates that access is not possible (i.e., “inaccessible”).

When the processor 21 reads and writes data from and to any one of the nonvolatile memories 121 (i.e., a memory area) by specifying a memory address, the processor 21 takes out the higher 20 bits of the memory address as a page number, and reads, out of the page table 211, an entry (i.e., a set made up of a piece of access control information and a piece of address information) that is stored in correspondence with the entry number matching the page number.

In this situation, in the case where the read piece of access control information is “0”, the processor 21 generates a 32-bit address in which the read piece of address information is the higher 20 bits and the memory address specified as the access target is the lower 12 bits. The processor then accesses the one of the nonvolatile memories 121 by using the generated 32-bit address. In other words, each of the pieces of address information in the page table 211 shows the higher 20 bits of the address of a different one of the memory pages in the nonvolatile memory 121.

On the other hand, in the case where the read piece of access control information is “1”, the processor 21 refers to the piece of address information in the corresponding entry. In the case where the piece of address information is “0(00000)”, the processor 21 judges that the memory page that corresponds to the piece of address information is not assigned in the nonvolatile memory 121. On the contrary, in the case where the piece of address information is a value other than “0”, the processor 21 judges that the memory page that corresponds to the piece of address information is assigned in the nonvolatile memory 121, but the memory area that contains the memory page is in the stop mode.

The translation lookaside buffer 212 is a cache that stores therein one or all of the entries in the page table 211. When the address conversion process as described above is performed, it is possible to have the process performed at a higher speed by using the entries stored in the translation lookaside buffer 212.

In addition, according to the present modification example, it is possible to suspend the execution of the program performed by the processor 21, by using the entries in the page table 211. More specifically, by setting the piece of access control information in an entry (i.e., the address information) specifying a memory page contained in each of the memory areas in the stop mode to “1” (i.e., “inaccessible”), it is possible to cause an interrupt (i.e., a page fault) when the processor 21 has accessed any of the memory areas that are in a stop state. By configuring the electric power-source managing unit 122 so as to exercise the electric power control for the nonvolatile memories 121 when the page fault has occurred, it is possible to implement the same electric power controlling process as the one according to the first embodiment.

Next, an operation of the processor 21 will be explained, with reference to FIG. 10. FIG. 10 is a flowchart of a procedure in an access process performed on any of the memory devices 12. First, when the processor 21 attempts to access a memory page for which the piece of access control information in the page table 211 is indicated as “inaccessible” or attempts to access a read-only memory page, a page fault occurs (Step S41).

After that, based on the entry in the page table 211 that corresponds to the memory page that has caused the page fault, the processor 21 judges whether the page fault that has occurred at Step S41 is a page fault due to a virtual storage (Step S42). In the case where the corresponding piece of access control information is “1” (i.e., inaccessible) and also the corresponding piece of address information is “0” (00000), the processor 21 judges that the page fault is a page fault due to a virtual storage (Yes at Step S42). Subsequently, the processor 21 swaps pages between a secondary storage device (i.e., a virtual storage device) (not shown) and the nonvolatile memory 121 (Step S43), and the process ends.

On the contrary, in the case where the processor 21 has judged at Step S42 that the corresponding piece of access control information is “1”, and also, the corresponding piece of address information is a value other than “0” (No at Step S42), the processor 21 refers to the register values in the mode setting register group 123 and judges whether the memory area (i.e., the access target area) containing the memory page specified by the piece of address information is in the stop mode (Step S44). In the case where the processor 21 has judged that the access target area is in the active mode (No at Step S44), the process proceeds to Step S47 immediately.

On the other hand, in the case where the processor 21 has judged at Step S44 that the access target area is in the stop mode (Yes at Step S44), the processor 21 sets the register value in the mode setting register group 123 that corresponds to the access target area to “ON” (Step S45). After that, the processor 21 waits the predetermined period of time until the access target area starts operating in a stable manner (Step S46), and the process proceeds to Step S47.

Subsequently, at Step S47, the processor 21 sets the piece of access control information in the same entry as the piece of access control information used as the target of the judgment process at Step S42 to “0” (i.e., accessible) (Step S47). After that, the processor 21 deletes the entry of which the setting has been changed at Step S47 from the translation lookaside buffer 212 (Step S48). Subsequently, the processor 21 resumes the process that caused the page fault at Step S41 (Step S49), and the process ends.

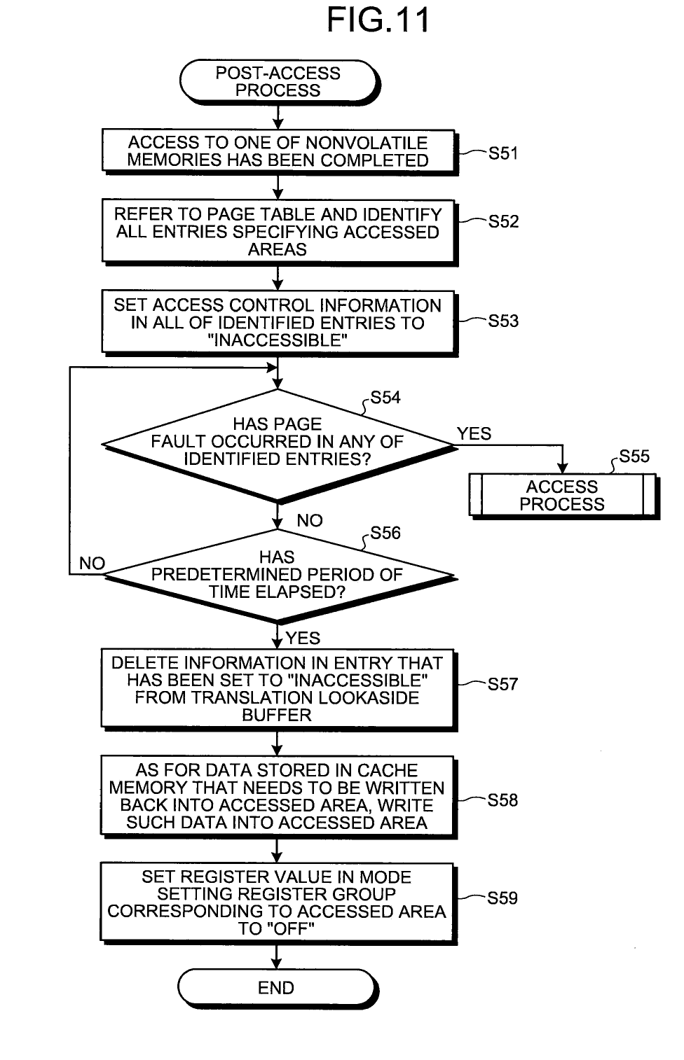

Next, a process that is performed after access made to any of the memory devices 12 has been completed will be explained, with reference to FIG. 11. FIG. 11 is a flowchart of a procedure in a post-access process performed by the processor 21.

When having completed the execution of a program or the like and completed the access to one of the nonvolatile memories 121 (Step S51), the processor 21 refers to the page table 211 and identifies all the entries that specify the memory areas that have been accessed (i.e., the accessed areas) (Step S52).

After that, in each of all the entries that have been identified at Step S52, the processor 21 sets the contained piece of access control information to “inaccessible” (Step S53).

Subsequently, the processor 21 judges whether another attempt has been made to access any of the entries identified at Step S52 (i.e., whether a page fault has occurred) (Step S54). In the case where the processor 21 has detected that a page fault has occurred (Yes at Step S54), the processors 21 performs the access process explained with reference to FIG. 10 on the entry in which the page fault has occurred (Step S55).

On the contrary, in the case where the processor 21 detects no page fault at Step S54 (No at Step S54), the processor 21 judges whether a predetermined period of time has elapsed since the access made to the nonvolatile memory is completed (Step S56). In the case where the processor 21 has judged that the predetermined period of time has not yet elapsed (No at Step S56), the process returns to Step S54.

On the contrary, in the case where the processor 21 has judged at Step S56 that the predetermined period of time has elapsed (Yes at Step S56), the processor 21 deletes the information in the entry of which the setting has been changed to “inaccessible” at Step S53, from the translation lookaside buffer 212 (Step S57).

In the case where the processor 21 includes a write-back cache memory as explained above, after the process at Step S57 is performed, the processor 21 reads the data that needs to be written back into the accessed memory area from the cache memory and writes the read data back into the memory area (Step S58). After that, the processor 21 sets the register value in the mode setting register group 123 that corresponds to the accessed area to “OFF” (Step S59), and the process ends. According to the present modification example, the post-access process to change the operation mode from the “active mode” to the “stop mode” is performed immediately after the access process is performed. However, another arrangement is acceptable in which the process is ended once the access made to the memory area has been completed, before the post-access process is performed as another process.

As explained above, according to the modification example of the first embodiment, it is possible to exercise the electric power control individually in units of memory areas included in each of the nonvolatile memories, by using the memory managing mechanism included in the processor 21. Thus, it is possible to easily apply the electric power control process to the processor including the memory managing mechanism. Accordingly, it is possible to reduce the electric power consumption in a larger number of information processing apparatuses.

In the first embodiment described above, the nonvolatile memories and the electric power-source managing units are provided in a one-to-one correspondence. In a second embodiment of the present invention explained below, a plurality of electric power-source managing units are provided for one nonvolatile memory. Some of the configurations that are the same as those in the first embodiment will be referred to by using the same reference characters, and the explanation thereof will be omitted.

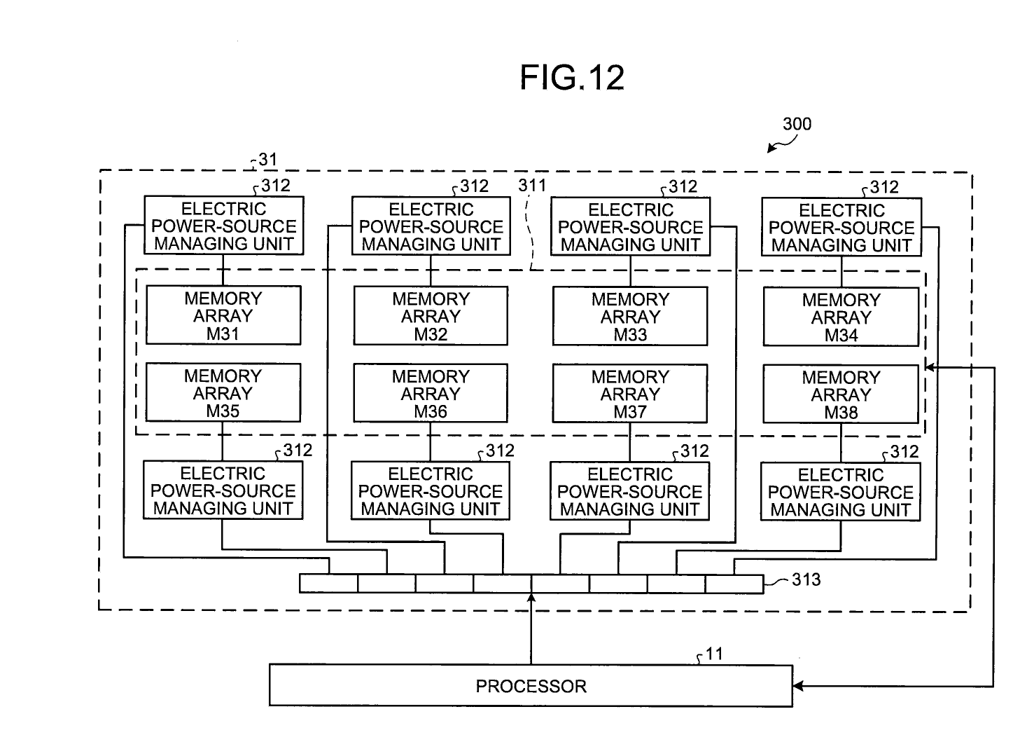

FIG. 12 is a diagram of an information processing apparatus 300 according to the second embodiment. Although only one memory device 31 is shown in FIG. 12, the relationship between the processor 11 and the memory devices 31 are the same as the relationship shown in FIG. 1.

As shown in FIG. 12, each of the memory devices 31 includes a nonvolatile memory 311, electric power-source managing units 312, and a mode setting register group 313. The nonvolatile memory 311 includes a plurality of memory arrays M31 to M38. Each of the memory arrays M31 to M38 is an area that actually stores data therein, within the nonvolatile memory 311. The memory arrays M31 to M38 correspond to the memory areas described above. Each of the memory arrays M31 to M38 may have an arbitrary storage capacity.

Each of the electric power-source managing unit 312 is provided in correspondence with a different one of the memory arrays M31 to M38. The electric power-source managing units 312 are connected to the mode setting register group 313 in such a manner that each of the register values that respectively correspond to the memory arrays M31 to M38 is input to the corresponding one of the electric power-source managing units 312. Each of the electric power-source managing units 312 monitors the register value in such a register in the mode setting register group 313 that is connected thereto and controls the electric power supply to such a memory array that is connected thereto according to the register value (i.e., ON or OFF). In the second embodiment, the registers in the mode setting register group 313 are provided in one place in a concentrated manner; however, the configuration is not limited to this example. Another arrangement is acceptable in which each of the registers is positioned near the corresponding one of the electric power-source managing units 312 in a distributed manner.

Like in the first embodiment, when it has become necessary for the processor 11 to access any one of the nonvolatile memories 311 (i.e., a memory array), the processor 11 sets the register value in the mode setting register group 313 that corresponds to the memory array within the nonvolatile memory 311 that is the access target to “ON”. The operation performed by the processor 11 to set the register value is performed in the same manner as in the first embodiment described above.

Normally, the bus connected to the processor 11 is connected to each of the nonvolatile memory 311 so that data can be read and written from and to the memory arrays. Thus, it is possible to use the connection for setting the register values in the mode setting register group 313. The procedure in the electric power controlling process performed by each of the electric power-source managing units 312 is the same as the procedure in the electric power controlling process according to the first embodiment described above. Thus, the explanation thereof will be omitted.

As explained above, according to the second embodiment, it is possible to reduce the electric power consumption of the nonvolatile memories 311 by exercising the electric power control in units of memory arrays (i.e., in units of memory areas) that are included in each of the nonvolatile memories 311. Thus, it is possible to exercise the electric power control related to the nonvolatile memories more efficiently.

Next, a third embodiment of the electric power controlling device according to the present invention will be explained. In the second embodiment described above, the electric power supply is controlled in units of memory arrays that are included in each of the nonvolatile memories. In the third embodiment, the electric power supply is controlled in units of memory areas (hereinafter, “divided memory areas”) that are obtained by further dividing each of the memory arrays into smaller sections. Some of the configurations that are the same as those in the first or the second embodiment described above will be referred to by using the same reference characters, and the explanation thereof will be omitted.

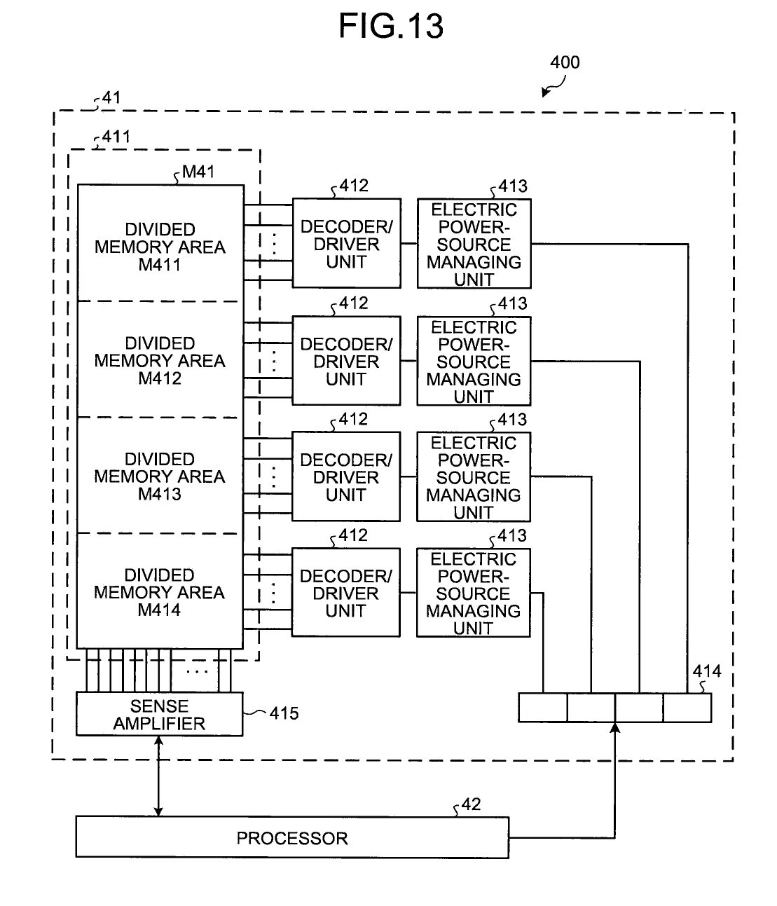

FIG. 13 is a diagram of an information processing apparatus 400 according to the third embodiment. Although only one memory array M41 among the plurality of memory arrays included in a nonvolatile memory 411 is shown in FIG. 13, the relationship between the nonvolatile memory 411 and the memory array M41 is the same as the relationship shown in FIG. 12. In addition, the relationship between a processor 42 and memory devices 41 is the same as the relationship shown in FIG. 1.

As shown in FIG. 13, each of the memory devices 41 includes the nonvolatile memory 411 (including the memory array M41), decoder/driver units 412, electric power-source managing units 413, a mode setting register group 414, and a sense amplifier 415.

The memory array M41 is a memory area that is a constituent element of the nonvolatile memory 411 and corresponds to any one of the memory arrays M31 to M38 included in the nonvolatile memory 311 shown in FIG. 12. In the present example, the memory area of the memory array M41 is made up of divided memory areas M411 to M414 that are obtained by further dividing the memory area into smaller sections. Each of the divided memory areas may have an arbitrary storage capacity.

Each of the decoder/driver units 412 is provided in correspondence with a different one of the divided memory areas in the memory array M41. Each of the decoder/driver units 412 causes the corresponding one of the divided memory areas to be in the active mode (i.e., to be accessible) by transmitting a signal to make the divided memory area (i.e., an address space) effective to the memory array M41.

Each of the electric power-source managing units 413 is provided in correspondence with a different one of the decoder/driver units 412. Each of the electric power-source managing units 413 controls the electric power supply to the corresponding decoder/driver unit 412 according to the register value (i.e., ON or OFF) specified in the corresponding one of the registers in the mode setting register group 414. In the present example, the mode setting register group 414 includes the plurality of registers each of which corresponds to a different one of the divided memory areas M411 to M414. The mode setting register group 414 is configured so that each of the register values in the registers is input to the one of the electric power-source managing units 413 that corresponds to the corresponding one of the divided memory areas.

When any one of the electric power-source managing units 413 has detected that the register value that corresponds thereto has changed to the ON state, the electric power-source managing unit 413 causes the decoder/driver unit 412 connected thereto to operate by start supplying electric power to the decoder/driver unit 412. In other words, the electric power-source managing unit 413 causes the divided memory area corresponding to the decoder/driver unit 412 to be in the active mode by causing the decoder/driver unit 412 to operate.

On the other hand, when any one of the electric power-source managing units 413 has detected that the register value that corresponds thereto has changed to the OFF state, the electric power-source managing unit 413 causes the decoder/driver unit 412 connected thereto to stop operating by blocking or lowering the electric power supply to the decoder/driver unit 412. In other words, the electric power-source managing unit 413 causes the divided memory area corresponding to the decoder/driver unit 412 to be in the stop mode by causing the decoder/driver unit 412 to stop operating.

The sense amplifier 415 is a circuit that amplifies the voltage used in the access to the memory array M41. The processor 42 accesses each of the divided memory areas M411 to M414 in the memory array M41 via the sense amplifier 415.

The processor 42 is a processing device similar to the processor 11 described above. The processor 42 performs various types of processes while using the nonvolatile memories 411 as the main storage devices. Also, the processor 42 sets the register value in the mode setting register group 414 that corresponds to the memory array or the divided memory area that is the access target to “ON”. The operation performed by the processor 42 to set the register values is performed in the same manner as in the first embodiment described above.

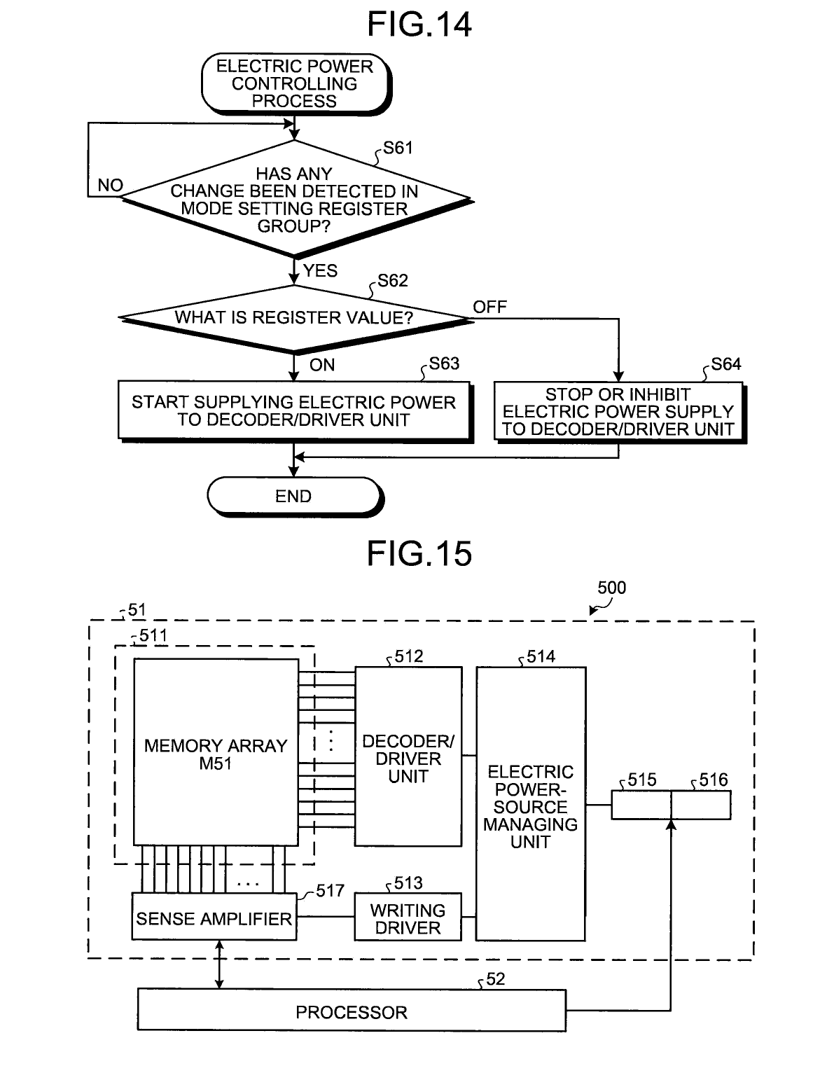

Next, an operation of each of the memory devices 41 will be explained, with reference to FIG. 14. FIG. 14 is a flowchart of a procedure in an electric power controlling process performed by each of the electric power-source managing units 413. First, the electric power-source managing unit 413 monitors the state of the corresponding register in the mode setting register group 414 (No at Step S61). When the electric power-source managing unit 413 has detected that the corresponding register value in the mode setting register group 414 has been changed by the processor 42 (Yes at Step S61), the electric power-source managing unit 413 identifies the corresponding register value in the mode setting register group 414 (Step S62).

In the case where the electric power-source managing unit 413 has judged that the register value in the mode setting register group 414 is “ON” (ON at Step S62), the electric power-source managing unit 413 causes the divided memory area corresponding to the decoder/driver unit 412 connected to the electric power-source managing unit 413 to be in an accessible state (i.e., an active state) by start supplying electric power to the decoder/driver unit 412 (Step S63), and the process ends.

On the other hand, in the case where the electric power-source managing unit 413 has judged that the register value in the mode setting register group 414 is “OFF” (OFF at Step S62), the electric power-source managing unit 413 causes the divided memory area corresponding to the decoder/driver unit 412 connected to the electric power-source managing unit 413 to be in an inaccessible state (i.e., a stop state) by stopping or inhibiting the electric power supply to the decoder/driver unit 412 (Step S64), and the process ends.

As explained above, according to the third embodiment, it is possible to further reduce the electric power consumption of the nonvolatile memories by exercising the electric power control in units of divided memory areas that are obtained by dividing the memory arrays (i.e., the memory areas) included in each of the nonvolatile memories 411 into sections. Consequently, it is possible to exercise the electric power control related to the nonvolatile memories more efficiently.

Next, a fourth embodiment of the electric power controlling device according to the present invention will be explained. According to the fourth embodiment, the electric power supply is controlled in units of memory arrays included in each of the nonvolatile memories, and also, access control is exercised in units of memory arrays. Some of the configurations that are the same as those in the first, the second, or the third embodiment will be referred to by using the same reference characters, and the explanation thereof will be omitted.

FIG. 15 is a diagram of an information processing apparatus 500 according to the fourth embodiment. Although only one memory array M51 among the plurality of memory arrays included in any one of the nonvolatile memories 511 is shown in FIG. 15, the relationship between the nonvolatile memory 511 and the memory array M51 is the same as the relationship shown in FIG. 12. In addition, the relationship between a processor 52 and memory devices 51 is the same as the relationship shown in FIG. 1.

As shown in FIG. 15, each of the memory devices 51 includes a nonvolatile memory 511 (including the memory array M51), a decoder/driver unit 512, a writing driver 513, an electric power-source managing unit 514, a mode setting register 515, an access controlling register 516, and a sense amplifier 517.

The memory array M51 is a memory area that is a constituent element of the nonvolatile memory 511 and corresponds to any one of the memory arrays M31 to M38 included in the nonvolatile memory 311 shown in FIG. 12. The decoder/driver unit 512 is provided in correspondence with the one memory array. The decoder/driver unit 512 causes the memory array M51 to be in the active mode (i.e., to be accessible) by transmitting a signal to make the memory array M51 effective to the memory array M51.

The writing driver 513 is a driver that, when data needs to be written to the memory array M51, supplies electric current that is required in the writing of the data to the sense amplifier 517. The electric power-source managing unit 514 is connected to the decoder/driver unit 512 and the writing driver 513. According to a combination of the register values specified in the mode setting register 515 and the access controlling register 516, the electric power-source managing unit 514 controls the electric power supply to the decoder/driver unit 512 and the writing driver 513.

In the present example, the mode setting register 515 includes the one register used for exercising the electric power control related to the memory array M51. The register value (i.e., 0 or 1) is input to the electric power-source managing unit 514. When the register value in the mode setting register 515 is “0”, the operation mode of the memory array M51 is defined as the OFF state (i.e., the stop mode). On the contrary, when the register value is “1”, the operation mode of the memory array M51 is defined as the ON state (i.e., the active mode).

The access controlling register 516 includes the one register used for defining the access control setting related to reading and writing data from and to the memory array M51. The register value (i.e., 0 or 1) is input to the electric power-source managing unit 514. In the present example, when the register value in the access controlling register 516 is “0”, the memory array M51 is defined to be read-only. On the contrary, when the register value is “1”, the memory array M51 is defined to be readable/writable. According to the fourth embodiment, the register values used in the access controlling register 516 are predetermined for each of the memory arrays. However, another arrangement is acceptable in which the processor 52 specifies the setting in the access controlling register 516.

In the case where the register value in the mode setting register 515 is “0”, the electric power-source managing unit 514 causes the decoder/driver unit 512 and the writing driver 513 to be in a stop state by stopping or inhibiting the electric power supply to the decoder/driver unit 512 and the writing driver 513. Further, in the case where the register value in the mode setting register 515 is “1”, but the register value in the access controlling register 516 is “0”, the electric power-source managing unit 514 causes the decoder/driver unit 512 to be in an active state by starting the electric power supply to the decoder/driver unit 512 and causes the writing driver 513 to be in a stop state by stopping or inhibiting the electric power supply to the writing driver 513. Furthermore, in the case where the register value in the mode setting register 515 is “1”, but the register value in the access controlling register 516 is “1”, the electric power-source managing unit 514 causes the decoder/driver unit 512 and the writing driver 513 to be in an active state by starting the electric power supply to the decoder/driver unit 512 and the writing driver 513.

The sense amplifier 517 is a circuit that amplifies the voltage used in the access to the memory array M51. The processor 52 accesses the memory array M51 via the sense amplifier 517.

The processor 52 performs various types of processes while using the nonvolatile memories 511 as the main storage devices. In the present example, when the processor 52 needs to access any one of the nonvolatile memories 511, the processor 52 informs the sense amplifier 517 of the memory area that is the access target, in units of memory arrays included in the nonvolatile memory 511. Also, the processor 52 sets the register value in the mode setting register 515 corresponding to the memory array that is the access target to “ON”. The operation performed by the processor 52 to set the register value is performed in the same manner as in the first embodiment described above.

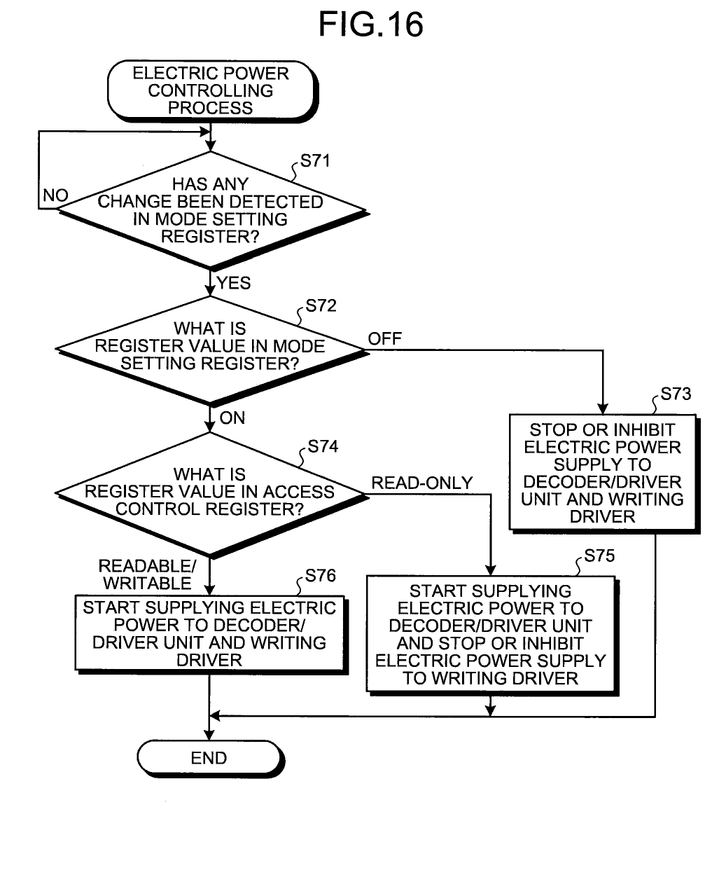

Next, an operation of each of the memory devices 51 will be explained, with reference to FIG. 16. FIG. 16 is a flowchart of a procedure in an electric power controlling process performed by the electric power-source managing unit 514. First, the electric power-source managing unit 514 monitors the state of the mode setting register 515 (No at Step S71). When the electric power-source managing unit 514 has detected that the register value in the mode setting register 515 has been changed by the processor 52 (Yes at Step S71), the electric power-source managing unit 514 identifies the register value in the mode setting register 515 (Step S72).

In the case where the electric power-source managing unit 514 has judged that the register value in the mode setting register 515 is “OFF” (OFF at Step S72), the electric power-source managing unit 514 causes the decoder/driver unit 512 and the writing driver 513 connected thereto to stop operating by stopping or inhibiting the electric power supply to the decoder/driver unit 512 and the writing driver 513 (Step S73), and the process ends.

On the other hand, in the case where the electric power-source managing unit 514 has judged at Step S72 that the register value in the mode setting register 515 is “ON” (ON at Step S72), the electric power-source managing unit 514 further judges whether the register value in the access controlling register 516 indicates “read-only” or “readable/writable” (Step S74).

At Step S74, in the case where the electric power-source managing unit 514 has judged that the register value in the access controlling register 516 indicates “read-only” (read-only at Step S74), the electric power-source managing unit 514 starts supplying electric power to the decoder/driver unit 512 connected thereto and stops or inhibits the electric power supply to the writing driver 513 (Step S75), and the process ends.

On the other hand, in the case where the electric power-source managing unit 514 has judged at Step S74 that the register value in the access controlling register 516 indicates “readable/writable” (readable/writable at Step S74), the electric power-source managing unit 514 starts supplying electric power supply to the decoder/driver unit 512 and the writing driver 513 connected thereto (Step S76), and the process ends.

As explained above, it is possible to exercise the electric power control individually in units of memory areas that are included in each of the nonvolatile memories. In addition, it is possible to exercise the electric power control of the devices involved the accesses based on the access control setting specified for each of the memory areas. Thus, it is possible to exercise the electric power control related to the nonvolatile memories more efficiently. In addition, it is possible to reduce the electric power consumption of the entire information processing apparatus.

According to the fourth embodiment, the electric power supply to the writing driver 513 is blocked or lowered to cause the memory array M51 to be read-only. However, the configuration is not limited to this example. For example, another configuration is acceptable in which the memory array M51 is arranged to be read-only by configuring the circuit so as to ignore a writing request signal transmitted from the processor 52.

The four exemplary embodiments of the present invention have been explained above. However, the present invention is not limited to these exemplary embodiments. Various changes, substitutions, and additions can be applied to the present invention without departing from the gist of the present invention.

For instance, in the exemplary embodiments above, the examples in which the memory devices are used as the main storage devices are explained; however, the present invention is not limited to these examples. It is possible to apply the present invention to a situation where the memory devices are used as auxiliary storage devices that store therein document files or image files. In this situation, it is preferable to have an arrangement where one or more memory areas are exclusively used for storing therein the files, so that these memory areas are normally in the stop mode, and only when it is necessary to perform an operation on any of the files, the memory area is changed into the active mode. With this arrangement, it is possible to reduce the electric power consumption of the auxiliary storage devices. It is also possible to prevent the files from being damaged by an unexpected operation caused by, for example, a program error.

Also, the auxiliary storage devices may have an arrangement as explained in the description of the fourth embodiment where it is possible to configure the access control setting for each of the memory areas. In this situation, it is preferable to have an arrangement in which the one or more memory areas used for storing files therein are normally configured to be read-only, so that only when it is necessary to write data to any of the memory areas, the access control setting is changed to readable/writable, and the setting is changed back to read-only when the process is finished. With this arrangement, it is possible to prevent the files stored in the memory areas from being damaged by an unexpected operation caused by, for example, a program error.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A memory device comprising:
a memory unit that is nonvolatile and is made up of a plurality of memory areas;
first retaining units each of which is provided in correspondence with a different one of the memory areas and each of which retains first setting information that defines whether a corresponding one of the memory areas is in an active state or a stop state; and
an electric power-source controlling unit that supplies electric power to one or more of the memory areas that correspond to the first setting information defining the memory areas to be in the active state, and stops electric power supply to one or more of the memory areas that correspond to the first setting information defining the memory areas to be in the stop state.

2. The device according to claim 1, further comprising a setting changing unit that changes each of settings in the first setting information, in units of memory areas.

3. The device according to claim 1, further comprising:
writing units each of which is provided in correspondence with a different one of the memory areas and each of which writes data to a corresponding one of the memory areas; and
second retaining units each of which is provided in correspondence with a different one of the memory areas and each of which retains second setting information that defines whether a corresponding one of the memory areas is readable/writable or read-only, wherein
the electric power controlling unit supplies electric power to one or more of the writing units provided in correspondence with one or more of the memory areas that correspond to the second setting information defining the memory areas to be readable/writable, and stops electric power supply to one or more of the writing units provided in correspondence with one or more of the memory areas that correspond to the second setting information defining the memory areas to be read-only.

4. The device according to claim 1, wherein the memory unit is configured with one of a Magnetoresistive Random Access Memory (MRAM), a Ferroelectric Random Access Memory (FeRAM), a Phase-change Random Access Memory (PRAM), and a Resistance Random Access Memory (RRAM).

5. An information processing apparatus comprising:
a memory unit that is nonvolatile and is made up of a plurality of memory areas;
first retaining units each of which is provided in correspondence with a different one of the memory areas and each of which retains first setting information that defines whether a corresponding one of the memory areas is in an active state or a stop state;
an accessing unit that is operable to make access to the memory unit;
an identifying unit that identifies one of the memory areas containing an address that is a target of the access as an access target area;
a setting changing unit that changes a setting so that the first setting information corresponding to the access target area defines the access target area to be in the active state; and
an electric power-source controlling unit that supplies electric power to one or more of the memory areas that correspond to the first setting information defining the memory areas to be in the active state, and stops electric power supply to one or more of the memory areas that correspond to the first setting information defining the memory areas to be in the stop state.

6. The apparatus according to claim 5, further comprising a determining unit that determines the setting in the first setting information corresponding to the access target area, wherein
the setting changing unit changes the setting so that the first setting information defines the access target area to be in the active state, when the determining unit determines that the first setting information defines the access target area to be in the stop state.

7. The apparatus according to claim 5, further comprising a table storage unit that stores an access management table that correspondingly records address ranges of the memory areas and access information, each of the access information showing whether a corresponding one of the memory areas is accessible or not, wherein
the identifying unit compares the address with each of the address ranges of the memory areas recorded in the access management table, and identifies one of the memory areas that corresponds to the address range containing the address, as the access target area.

8. The apparatus according to claim 7, wherein the setting changing unit changes the setting so that the first setting information that corresponds to the access target area defines the access target area to be in the active state, and also changes another setting so that the access information corresponding to the access target area shows that the access target area is accessible, when one of the access information recorded in the access management table that corresponds to the access target area shows that the access target area is inaccessible.

9. The apparatus according to claim 7, wherein, after the accessing unit has completed making the access to the memory unit, the setting changing unit changes the setting so that the first setting information that corresponds to the access target area defines the access target area to be in the stop state, and also changes another setting so that one of the access information in the access management table that corresponds to the access target area shows that the access target area is inaccessible.

10. The apparatus according to claim 7, wherein, when a predetermined period of time has elapsed since the accessing unit has completed making the access to the memory unit, the setting changing unit changes settings so that the first setting information that correspond to all the memory areas define that all the memory areas are in the stop state, and also changes settings so that the access information in the access management table that correspond to all the memory areas show that all the memory areas are inaccessible.

11. The apparatus according to claim 7, further comprising:
a first cache unit that is a write-back cache system and in which data of an address to which the access has been made by the accessing unit is cached; and
a write-back unit that, before the setting changing unit changes the setting so that the first setting information corresponding to the access target area containing the address is changed so as to define the access target area to be in the stop state, writes the data regarding the access target area that has been cached in the first cache unit back into the access target area.

12. The apparatus according to claim 7, wherein the access management table is a page table used in a memory managing mechanism.

13. The apparatus according to claim 12, further comprising:
a second cache unit into which information recorded in the access management table is cached in units of memory areas; and
a deleting unit that, every time the setting changing unit changes a setting in any one of the first setting information, deletes such information stored in the second cache unit that is related to one of the memory areas corresponding to the changed first setting information.

14. The apparatus according to claim 5, further comprising:
writing units each of which is provided in correspondence with a different one of the memory areas and each of which writes data to a corresponding one of the memory areas in response to a request from the accessing unit; and
second retaining units each of which is provided in correspondence with a different one of the memory areas and each of which retains a second setting information that defines whether a corresponding one of the memory areas is readable/writable or read-only, wherein
the electric power-source controlling unit supplies electric power to one or more of the writing units that are provided in correspondence with one or more of the memory areas that correspond to the second setting information defining the memory areas to be readable/writable, and stops electric power supply to one or more of the writing units that are provided in correspondence with one or more of the memory areas that correspond to the second setting information defining the memory areas to be read-only.

15. The device according to claim 5, wherein the memory unit is configured with one of a Magnetoresistive Random Access Memory (MRAM), a Ferroelectric Random Access Memory (FeRAM), a Phase-change Random Access Memory (PRAM), and a Resistance Random Access Memory (RRAM).

16. An electric power controlling method implemented by an information processing apparatus, the apparatus including a memory unit that is nonvolatile and is made up of a plurality of memory areas, and first retaining units each of which is provided in correspondence with a different one of the memory areas and each of which retains first setting information that defines whether a corresponding one of the memory areas is in an active state or a stop state, the method comprising:
making an access to the memory unit by an accessing unit;
identifying one of the memory areas containing an address that is a target of the access as an access target area by an identifying unit;
changing a setting so that the first setting information corresponding to the access target area defines the access target area to be in the active state, by a setting changing unit; and
supplying electric power to one or more of the memory areas that correspond to the first setting information defining the memory areas to be in the active state, and stopping electric power supply to one or more of the memory areas that correspond to the first setting information defining the memory areas to be in the stop state.
